(19) United States
(12) Patent Application Publication
(10) Pub. No.: US 2026/0281025 A1
(43) Pub. Date: Sep. 17, 2026

(54) SMART ROUTING RULE CACHING FOR ORTHOGONAL RULE ENTRIES

(71) Applicant: Dell Products L.P., Round Rock, TX (US)

(72) Inventors: Omer Margolin, Tel Aviv (IL); Ishay Zekri, Kfar Yona, Sharon (IL); Yaron Shust, Holon (IL)

(21) Appl. No.: 19/079,941

(22) Filed: Mar. 14, 2025

(51) Int. Cl. H04L 45/00; H04L 45/02

(52) U.S. Cl. CPC H04L 45/14; H04L 45/04

(57) ABSTRACT

Techniques for providing a smart routing rule caching mechanism for orthogonal routing rule entries. The techniques can be implemented in a storage system that includes a routing rule table for controlling access to multiple routing tables, and a routing rule cache table that can store one, two, or more recently used routing rules, each of which is orthogonal to a high number of routing rules stored in the routing rule table. The techniques include determining that attributes of a packet transmission match corresponding attributes of an orthogonal routing rule in the routing rule cache table. The techniques include moving the matched orthogonal routing rule to the top position of the routing rule cache table if not already in the top position. The techniques include, based on the matched orthogonal routing rule, accessing a routing table from among the multiple routing tables to lookup routing information for forwarding the packet transmission.

### BACKGROUND

Storage systems include storage processors coupled to arrays of storage drives, such as solid state drives (SSDs) and hard disk drives (HDDs). The storage processors receive and service storage input/output (IO) requests (e.g., write requests, read requests) issued by client computers (“clients”), which transmit the storage IO requests to the storage systems over one or more networks. The storage IO requests specify data blocks, data pages, data files, or other data elements to be written to or read from logical units (LUs), volumes (VOLs), filesystems, or other storage objects maintained on the storage drives. The storage systems use routing tables containing entries that specify routes for forwarding data (e.g., transmission control protocol (TCP) packets) to the clients. The storage systems have a number of Internet protocol (IP) or media access control (MAC) addresses through which they serve the clients. When a storage system receives a request transmission from a client, the storage system directs it to an IP or MAC address specified in the request transmission. When the storage system forwards a reply transmission to the client, the storage system directs it to the client's IP address specified in the request transmission. The storage system accesses a routing table to lookup routing information for forwarding the reply transmission to the client, such as an IP or MAC address of a gateway. The storage system can forward the reply transmission to the client over a local area network (LAN) using the IP or MAC address of the gateway, which provides a communications interface between the LAN and the Internet.

### SUMMARY

Storage systems can use routing rule tables to control access to multiple routing tables. Such routing rule tables contain entries that specify routing rules, which can be associated with numerical priority values that determine the order in which the routing rules are to be evaluated. In one embodiment, routing rules associated with lower numerical values have precedence and are evaluated first, while routing rules associated with higher numerical values are evaluated last. In this embodiment, if two or more routing rules in a routing rule table are associated with the same numerical value, then such routing rules are evaluated in the order in which they were entered into the routing rule table. Each routing rule in a routing rule table can map an IP address, MAC address, or connection mark associated with a transmission from a client to a routing table from which a route with the most specific destination address, as well as the lowest metric value, can be selected. If, having evaluated all routing rules in the routing rule table, it is determined that none is applicable for mapping the IP/MAC address or connection mark associated with the client's transmission to a routing table, then a default routing policy (e.g., using a default gateway) can be applied for forwarding a reply transmission to the client.

Storage systems can be deployed in complex configurations within large IP networks, which can be logically divided into a multitude of smaller network segments or subnetworks (“subnets”) to which specific ranges of IP addresses are assigned. In such complex network configurations, various IP addresses assigned to the multitude of subnets can be configured on multiple ports of the storage systems, thereby requiring the use of routing rule tables containing hundreds, thousands, tens of thousands, or more entries. However, using routing rule tables with such high numbers of entries can lead to performance degradation in the storage systems, as the routing rules in each routing rule table are typically evaluated in a sequential manner, according to priority, for every reply or other transmission to a client. To reduce the performance degradation that can result from using routing rule tables with high numbers of entries, a mechanism for caching recently used routing rules can be implemented. For example, while servicing a storage IO request that specifies a big chunk of data, a storage system may establish a TCP connection with the client, and repeatedly forward or receive TCP packets over the same TCP connection. Because the same routing rule would likely be used to access a routing table for each packet transmission over the TCP connection, storing the routing rule in a cache table may be beneficial for fast and easy table lookups. However, implementing such a caching mechanism for storing recently used routing rules can have drawbacks in that a routing rule stored in the cache table may be general enough to encompass a more specific routing rule in a routing rule table, potentially causing the wrong routing table to be accessed for forwarding a packet transmission to the client.

Techniques are disclosed herein for providing a smart routing rule caching mechanism for orthogonal routing rule entries. The disclosed techniques can be implemented in a storage system that uses a routing rule table to control access to multiple routing tables. The routing rule table can contain a high number of entries that specify routing rules, which can be associated with numerical priority values that determine the order in which the routing rules are to be evaluated. In the disclosed techniques, rather than simply storing one or more recently used routing rules in a cache table, a predetermined number (e.g., 1, 2, 3) of recently used routing rules can be stored in a routing rule cache table, each of which is orthogonal to routing rules in the routing rule table. In one embodiment, each routing rule has one or more attributes, and is deemed orthogonal to another routing rule if its combination of attributes is not encompassed by the attributes of the other routing rule. In other words, the attributes of the respective routing rules are independent of each other or nonoverlapping. The disclosed techniques can be applied in several scenarios of usage, namely, a first scenario, in which a routing rule is created and stored in a routing rule table; a second scenario, in which a routing rule cache table lookup is performed during processing of a packet transmission to a client; and a third scenario, in which a routing rule is removed from the routing rule cache table.

In the first scenario, the disclosed techniques can include providing a routing rule table that stores a plurality of routing rules according to their respective priorities (e.g., from highest priority to lowest priority), and a routing rule cache table that stores zero, one, two, three, or more routing rules, in which each routing rule stored in the routing rule cache table is orthogonal to each routing rule of higher priority stored in the routing rule table. The disclosed techniques can include creating a new routing rule, and storing it in the routing rule table according to its priority. The disclosed techniques can include making a first determination as to whether the newly created routing rule is orthogonal to each routing rule of higher priority in the routing rule table, if any. The disclosed techniques can include marking the newly created routing rule as either “orthogonal” or “nonorthogonal” based on the first determination. The disclosed techniques can include removing from the routing rule cache table any routing rule(s) not orthogonal to the newly created routing rule. The disclosed techniques can include making a second determination as to whether each routing rule of lower priority in the routing rule table, if any, is orthogonal to the newly created routing rule. The disclosed techniques can include marking each routing rule of lower priority as either “orthogonal” or “nonorthogonal” based on the second determination.

In the second scenario, a routing rule table stores a plurality of routing rules according to their respective priorities (e.g., from highest priority to lowest priority), in which each routing rule has been marked as “orthogonal” or “nonorthogonal”, in accordance with the requirements of the first scenario. Further, a routing rule cache table stores zero, one, two, three, or more recently used routing rules. The disclosed techniques can include performing processing of a packet transmission to a client. To that end, the disclosed techniques can include evaluating the routing rules stored in the routing rule cache table to determine whether any are applicable for mapping the packet transmission to one of multiple routing tables. In other words, a determination is made as to whether attributes (e.g., source IP/MAC address, connection mark) of the packet transmission match corresponding attributes of a routing rule in the routing rule cache table. The disclosed techniques can include, having determined that the packet transmission so matches a routing rule in the routing rule cache table, moving the matched routing rule to the first or top position of the routing rule cache table if not already in the top position. Otherwise, the disclosed techniques can include evaluating the routing rules stored in the routing rule table to determine whether the attributes of the packet transmission match corresponding attributes of a routing rule in the routing rule table. The disclosed techniques can include, having determined that the packet transmission so matches a routing rule in the routing rule table, determining whether the matched routing rule is marked as “orthogonal” or “nonorthogonal”. The disclosed techniques can include, having determined that the matched routing rule is marked as “orthogonal”, storing the matched routing rule in the top position of the routing rule cache table. The disclosed techniques can include, having determined that the matched routing rule is marked as “nonorthogonal”, avoiding storing the matched routing rule in the routing rule cache table. The disclosed techniques can include, based on the matched routing rule, accessing a routing table from among the multiple routing tables to lookup routing information for forwarding the packet transmission to the client. The disclosed techniques can include, in the event the packet transmission does not so match any routing rule in the routing rule table, applying a default routing policy for forwarding the packet transmission to the client.

In the third scenario, the disclosed techniques can include, in the event processing of a packet transmission is not performed relative to a routing rule in a routing rule table within a predetermined timeout period, removing the routing rule from a routing rule cache table if stored therein, and removing the routing rule from the routing rule table. The disclosed techniques can include, having removed the routing rule from the routing rule table, making one or more determinations as to whether any routing rules of lower priority than the removed routing rule, and currently marked as “nonorthogonal”, are now orthogonal to each routing rule of higher priority in the routing rule table. The disclosed techniques can include, based on the determinations, performing one of (i) changing markings of one or more of the routing rules of lower priority from “nonorthogonal” to “orthogonal”, and (ii) maintaining the markings of one or more of the routing rules of lower priority as “nonorthogonal”.

By providing a routing rule table and a routing rule cache table, in which each routing rule in the routing rule cache table is orthogonal to routing rules in the routing rule table, fast and easy table lookups of routing rules in the routing rule cache table can be achieved, while avoiding the possibility of any routing rules in the routing rule cache table being general enough to encompass a more specific routing rule in the routing rule table. In this way, performance degradation resulting from use of a routing rule table with a high number of entries can be reduced, without risking accessing the wrong routing table for forwarding a packet transmission to a client.

In certain embodiments, a method includes determining that attributes of a packet transmission to a client match corresponding attributes of a routing rule stored in a routing rule cache table. The routing rule cache table stores one or more routing rules, in which each stored routing rule is orthogonal to routing rules stored in a routing rule table. The method includes moving the matched routing rule to a top position of the routing rule cache table, if not already in the top position, and, based on the matched routing rule, accessing a routing table from among multiple routing tables to lookup routing information for forwarding the packet transmission to the client. The method includes forwarding the packet transmission to the client using the routing information.

In certain arrangements, the method includes storing a newly created routing rule in the routing rule table. The newly created routing rule is stored among a plurality of routing rules in the routing rule table according to their respective priorities. The method includes making a first determination as to whether the newly created routing rule is orthogonal to each routing rule of higher priority in the routing rule table.

In certain arrangements, the method includes, based on the first determination, marking the newly created routing rule in the routing rule table as either “orthogonal” or “nonorthogonal”.

In certain arrangements, the method includes removing any routing rules not orthogonal to the newly created routing rule from the routing rule cache table, and making a second determination as to whether each routing rule of lower priority than the newly created routing rule in the routing rule table is orthogonal to the newly created routing rule.

In certain arrangements, the method includes, based on the second determination, marking each routing rule of lower priority than the newly created routing rule in the routing rule table as either “orthogonal” or “nonorthogonal”.

In certain arrangements, the method includes performing processing of the packet transmission to the client, including determining that attributes of the packet transmission do not match corresponding attributes of a routing rule in the routing rule cache table. The method includes, having determined that the attributes of the packet transmission do not match corresponding attributes of a routing rule in the routing rule cache table, determining that the attributes of the packet transmission match corresponding attributes of a routing rule in the routing rule table. The routing rule table stores a plurality of routing rules according to their respective priorities.

In certain arrangements, the method includes, having determined that the attributes of the packet transmission match corresponding attributes of a routing rule in the routing rule table, determining that the matched routing rule is orthogonal to each routing rule of higher priority in the routing rule table.

In certain arrangements, the method includes, having determined that the matched routing rule is orthogonal to each routing rule of higher priority in the routing rule table, storing the matched routing rule in a top position of the routing rule cache table.

In certain arrangements, the method includes, based on the matched routing rule, accessing a routing table from among multiple routing tables to lookup information for forwarding the packet transmission to the client, and, based on the information in the accessed routing table, forwarding the packet transmission to the client.

In certain arrangements, the method includes determining that processing of a packet transmission to the client relative to a specified routing rule in the routing rule table has not been performed within a predetermined timeout period.

In certain arrangements, the method includes removing the routing rule from the routing rule table, and removing the routing rule from the routing rule cache table, if stored therein.

In certain arrangements, the method includes, having removed the routing rule from the routing rule table, determining that a routing rule of lower priority than the removed routing rule is now orthogonal to each routing rule of higher priority in the routing rule table. The routing rule of lower priority was previously marked as “nonorthogonal”. The method includes marking the routing rule of lower priority in the routing rule table as “orthogonal”.

In certain embodiments, a system includes a memory, and processing circuitry configured to execute program instructions out of the memory to determine that attributes of a packet transmission to a client match corresponding attributes of a routing rule stored in a routing rule cache table. The routing rule cache table stores one or more routing rules. Each stored routing rule is orthogonal to routing rules stored in a routing rule table. The processing circuitry is configured to execute the program instructions out of the memory to move the matched routing rule to a top position of the routing rule cache table, if not already in the top position. The processing circuitry is configured to execute the program instructions out of the memory to, based on the matched routing rule, access a routing table from among multiple routing tables to lookup routing information for forwarding the packet transmission to the client, and forward the packet transmission to the client using the routing information.

In certain arrangements, the processing circuitry is configured to execute the program instructions out of the memory to store a newly created routing rule in the routing rule table. The newly created routing rule is stored among a plurality of routing rules in the routing rule table according to their respective priorities. The processing circuitry is configured to execute the program instructions out of the memory to make a first determination as to whether the newly created routing rule is orthogonal to each routing rule of higher priority in the routing rule table, and, based on the first determination, mark the newly created routing rule in the routing rule table as either “orthogonal” or “nonorthogonal”.

In certain arrangements, the processing circuitry is configured to execute the program instructions out of the memory to remove any routing rules not orthogonal to the newly created routing rule from the routing rule cache table, make a second determination as to whether each routing rule of lower priority than the newly created routing rule in the routing rule table is orthogonal to the newly created routing rule, and, based on the second determination, mark each routing rule of lower priority than the newly created routing rule in the routing rule table as either “orthogonal” or “nonorthogonal”.

In certain arrangements, the processing circuitry is configured to execute the program instructions out of the memory to perform processing of the packet transmission to the client, including determining that attributes of the packet transmission do not match corresponding attributes of a routing rule in the routing rule cache table. The processing circuitry is configured to execute the program instructions out of the memory to, having determined that the attributes of the packet transmission do not match corresponding attributes of a routing rule in the routing rule cache table, determine that the attributes of the packet transmission match corresponding attributes of a routing rule in the routing rule table. The routing rule table stores a plurality of routing rules according to their respective priorities.

In certain arrangements, the processing circuitry is configured to execute the program instructions out of the memory to, having determined that the attributes of the packet transmission match corresponding attributes of a routing rule in the routing rule table, determine that the matched routing rule is orthogonal to each routing rule of higher priority in the routing rule table, and, having determined that the matched routing rule is orthogonal to each routing rule of higher priority in the routing rule table, store the matched routing rule in a top position of the routing rule cache table.

In certain arrangements, the processing circuitry is configured to execute the program instructions out of the memory to, based on the matched routing rule, access a routing table from among multiple routing tables to lookup information for forwarding the packet transmission to the client, and, based on the information in the accessed routing table, forward the packet transmission to the client.

In certain arrangements, the processing circuitry is configured to execute the program instructions out of the memory to determine that processing of a packet transmission to the client relative to a specified routing rule in the routing rule table has not been performed within a predetermined timeout period, remove the routing rule from the routing rule table, and remove the routing rule from the routing rule cache table, if stored therein. The processing circuitry is configured to execute the program instructions out of the memory to, having removed the routing rule from the routing rule table, determine that a routing rule of lower priority than the removed routing rule is now orthogonal to each routing rule of higher priority in the routing rule table. The routing rule of lower priority was previously marked as “nonorthogonal”. The processing circuitry is configured to execute the program instructions out of the memory to mark the routing rule of lower priority in the routing rule table as “orthogonal”.

In certain embodiments, a computer program product includes a set of non-transitory, computer-readable media having program instructions that, when executed by processing circuitry, cause the processing circuitry to perform a method including determining that attributes of a packet transmission to a client match corresponding attributes of a routing rule stored in a routing rule cache table. The routing rule cache table stores one or more routing rules. Each stored routing rule is orthogonal to routing rules stored in a routing rule table. The method includes moving the matched routing rule to a top position of the routing rule cache table, if not already in the top position. The method includes, based on the matched routing rule, accessing a routing table from among multiple routing tables to lookup routing information for forwarding the packet transmission to the client, and forwarding the packet transmission to the client using the routing information.

Other features, functions, and aspects of the present disclosure will be evident from the Detailed Description that follows.

### BRIEF DESCRIPTION OF THE DRAWINGS

The foregoing and other objects, features, and advantages will be apparent from the following description of particular embodiments of the present disclosure, as illustrated in the accompanying drawings, in which like reference characters refer to the same parts throughout the different views.

FIG. 1a is a block diagram of an exemplary storage environment, in which techniques can be practiced for providing a smart routing rule caching mechanism for orthogonal routing rule entries;

FIG. 1b is a block diagram of an exemplary storage system, as well as an exemplary storage node included in the storage system, which can be employed within the storage environment of FIG. 1a;

FIG. 2a is a diagram of a first configuration of an exemplary routing rule table that can be implemented in the storage node of FIG. 1b, in which the first configuration of the routing rule table is described herein with reference to a first illustrative example;

FIGS. 2b, 2c, 2d, and 2e are diagrams of an exemplary routing rule cache table that can be implemented in the storage node of FIG. 1b, in which the routing rule cache table is described herein, in conjunction with the routing rule table of FIG. 2a, with reference to the first illustrative example;

FIG. 3a is a diagram of a second configuration of the routing rule table that can be implemented in the storage node of FIG. 1b, in which the second configuration of the routing rule table is described herein with reference to a second illustrative example;

FIG. 3b is a diagram of the routing rule cache table that can be implemented in the storage node of FIG. 1b, in which the routing rule cache table is described herein, in conjunction with the routing rule table of FIG. 3a, with reference to the second illustrative example;

FIG. 4a is a diagram of a third configuration of the routing rule table that can be implemented in the storage node of FIG. 1b, in which the third configuration of the routing rule table is described herein with reference to a third illustrative example;

FIG. 4b is a diagram of the routing rule cache table that can be implemented in the storage node of FIG. 1b, in which the routing rule cache table is described herein, in conjunction with the routing rule table of FIG. 4a, with reference to the third illustrative example;

FIG. 5 is a diagram of a fourth configuration of the routing rule table that can be implemented in the storage node of FIG. 1b, in which the fourth configuration of the routing rule table is described herein with reference to a fourth illustrative example;

FIG. 6a is a flow diagram of an exemplary method of providing a routing rule cache table for orthogonal routing rule entries;

FIG. 6b is a flow diagram of an exemplary method of storing a newly created routing rule in a routing rule table;

FIG. 6c is a flow diagram of an exemplary method of accessing a routing rule table and/or a routing rule cache table during processing of a packet transmission to a client; and

FIG. 6d is a flow diagram of an exemplary method of removing a routing rule from a routing rule table.

### DETAILED DESCRIPTION

Techniques are disclosed herein for providing a smart routing rule caching mechanism for orthogonal routing rule entries. The disclosed techniques can be implemented in a storage system that uses a routing rule table to control access to multiple routing tables. The routing rule table can contain a high number of entries that specify routing rules, which can be associated with numerical priority values that determine the order in which the routing rules are to be evaluated. In the disclosed techniques, a predetermined number (e.g., 1, 2, 3) of recently used routing rules can be stored in a routing rule cache table, in which each routing rule stored in the routing rule cache table is orthogonal to routing rules in the routing rule table. The disclosed techniques can include determining whether attributes of a packet transmission to a client match corresponding attributes of a routing rule in the routing rule cache table. The disclosed techniques can include, having determined that the packet transmission to the client matches a routing rule in the routing rule cache table, moving the matched routing rule to the first or top position of the routing rule cache table, if not already in the top position. The disclosed techniques can include, based on the matched routing rule, accessing a routing table from among the multiple routing tables to lookup routing information for forwarding the packet transmission to the client. In this way, performance degradation resulting from use of a routing rule table with a high number of entries can be reduced, without risking accessing the wrong routing table for forwarding a packet transmission to a client.

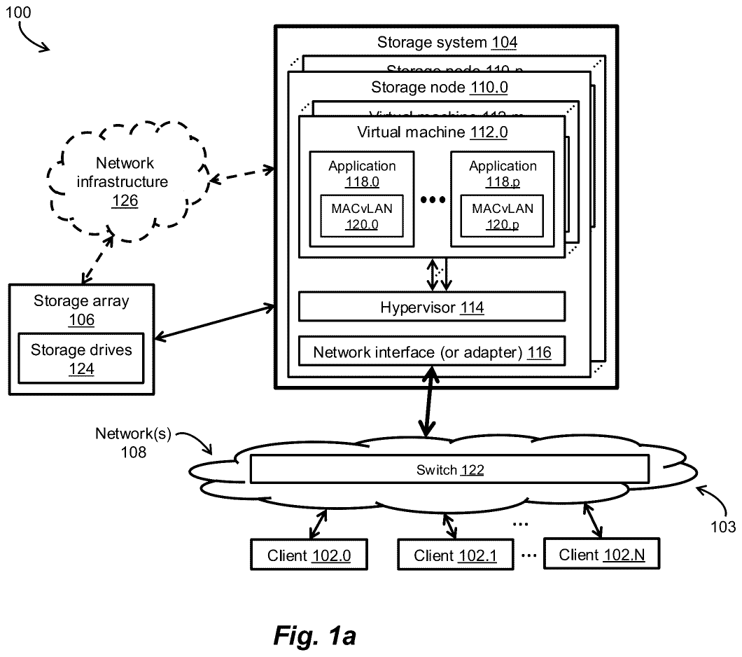

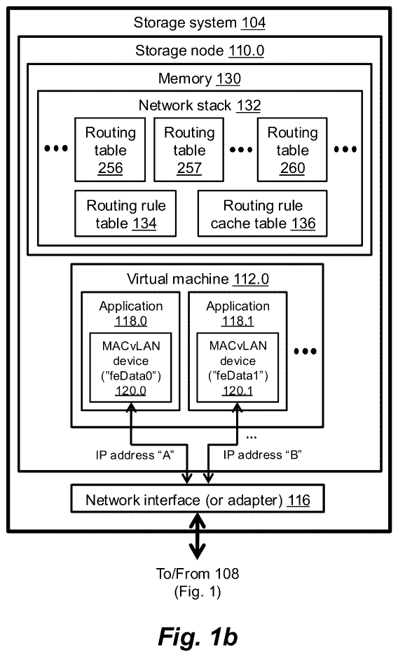

FIG. 1a depicts an illustrative embodiment of an exemplary storage environment 100 for providing a smart routing rule caching mechanism for orthogonal routing rule entries. As shown in FIG. 1a, the storage environment 100 can include a plurality of client computers (“clients”) 102.0, 102.1, . . . , 102.N, a storage system 104, a storage array 106, and a communications medium 103 that includes one or more networks 108. Each client 102.0, . . . , 102.N can provide, over the network(s) 108, storage input/output (IO) requests (e.g., small computer system interface (SCSI) commands, network file system (NFS) commands) to the storage system 104. Such storage IO requests (e.g., write requests, read requests) can direct the storage system 104 to write or read data blocks, data pages, data files, or any other suitable data elements to/from logical units (LUs), volumes (VOLs), virtual volumes (VVOLs) (e.g., VMware® VVOLs), filesystems, or any other suitable storage objects maintained on one or more storage drives 124 (e.g., solid state drives (SSDs), hard disk drives (HDDs), flash drives) of the storage array 106.

The communications medium 103, including the network(s) 108, can be configured to interconnect the plurality of clients 102.0, . . . , 102.N with the storage system 104, enabling them to communicate and exchange data and/or control signaling. As shown in FIG. 1a, the network(s) 108 can include a switch 122. The communications medium 103 is illustrated as a cloud to represent different network topologies, such as a storage area network (SAN) topology, a network attached storage (NAS) topology, a wide area network (WAN) topology, a local area network (LAN) topology, and so on. As such, the communications medium 103 can include copper-based communications devices and cabling, fiber optic devices and cabling, wireless devices, and so on, or any suitable combination thereof.

The storage system 104 can be connected directly to the storage array 106, or indirectly through an optional network infrastructure 126, which can include an Ethernet network, an InfiniBand network, a Fibre Channel (FC) network, or any other suitable network. As shown in FIG. 1a, the storage system 104 can include a plurality of storage processors (“storage nodes”) 110.0, . . . , 110.n. In one embodiment, each storage node 110.0, . . . , 110.n can include one or more virtual machines (or containers) (VMs) 112.0, . . . , 112.m, a hypervisor 114, and a network interface (or adapter) 116. In this embodiment, the VMs 112.0, . . . , 112.m can run (e.g., execute as threads) on the hypervisor 114, which can be implemented as a VMware® ESXi hypervisor of a Dell EMC PowerStore® storage system, or any other suitable hypervisor and/or storage system. Further, one or more software applications 118.0, . . . , 118.p can run within the VMs 112.0, . . . , 112.m using MACvLAN devices 120.0, . . . , 120.p, which are Linux® network drivers configured to allow virtual interfaces of the VMs 112.0, . . . , 112.m to be visible to the switch 122 within the network(s) 108. Using the MACvLAN devices 120.0, . . . , 120.p, each virtual interface can receive a unique Internet protocol (IP) address and a unique media access control (MAC) address, whereby the virtual interface is directly exposed to the switch 122 connecting the storage system 104 to the clients 102.0, . . . , 102.N. In this way, several IP or MAC addresses can be assigned to the network interface 116, effectively splitting the network interface 116 into several sub-interfaces or ports with their own IP or MAC addresses.

FIG. 1b depicts a further representation of the storage system 104 of FIG. 1a, including the storage node 110.0. It is noted that each of the storage nodes 110.1, . . . , 110.n included in the storage system 104 of FIG. 1a can be configured like the storage node 110.0 of FIG. 1b. As shown in FIG. 1b, the storage node 110.0 can include a memory 130, which can accommodate (i.e., by operation of program instructions or code) a network stack 132, and at least the virtual machine 112.0. The network stack 132 can provide transport protocol services, such as transmission control protocol (TCP) and/or user datagram protocol (UDP) services, and can function as an intermediary between the network interface 116 and the respective software applications 118.0, 118.1, . . . , running on the VM 112.0. The network stack 132 can include, for each VM (e.g., VM 112.0), a set of routing tables (e.g., at least routing tables 256, 257, . . . , 260), a routing rule table 134, and a routing rule cache table 136.

It is noted that the storage system 104 can be deployed in complex configurations within a large IP network, which can be logically divided into a multitude of smaller network segments or subnetworks (“subnets”) to which specific ranges of IP addresses can be assigned. In such complex network configurations, various IP addresses assigned to the multitude of subnets can be configured on multiple ports of the storage system 104, thereby requiring the routing rule table 134 to contain hundreds, thousands, tens of thousands, or more entries. However, using a routing rule table with such a high number of entries can lead to performance degradation in a storage system, as the routing rules in each routing rule table are typically evaluated in a sequential manner, according to priority, for every reply or other transmission to a client. Moreover, implementing a conventional caching mechanism for storing recently used routing rules can have drawbacks in that a routing rule stored in a cache table may be general enough to encompass a more specific routing rule in a routing rule table, potentially causing the wrong routing table to be accessed for forwarding a packet transmission to the client.

In the disclosed techniques, rather than simply storing one or more recently used routing rules in a cache table, a predetermined number (e.g., 1, 2, 3) of recently used routing rules can be stored in the routing rule cache table 136, in which each routing rule stored in the routing rule cache table 136 is orthogonal to routing rules in the routing rule table 134. In one embodiment, each routing rule has one or more attributes, and is deemed orthogonal to another routing rule if its combination of attributes is not encompassed by the attributes of the other routing rule. In other words, the attributes of the respective routing rules are independent of each other or nonoverlapping. Such attributes can be set to a value, not set, or set with a wildcard (e.g., “all”). In one embodiment, the attributes of the routing rules can correspond to one or more Linux® attributes, such as the following:
from PREFIX
   Select the source address prefix to match.
to PREFIX
   Select the destination address prefix to match.
tos TOS
   Select the type of service to match.
fwmark MARK
   Select the firewall mark to match.
iif NAME
   Select the incoming device to match.
oif NAME
   Select the outgoing device to match.
priority PREFERENCE
   The priority of a routing rule. PREFERENCE is an unsigned integer value, in which a higher integer value corresponds to a lower priority.
uidrange NUMBER-NUMBER
   Select the user identifier to match, in which NUMBER-NUMBER corresponds to a range of user identifiers.
ipproto PROTOCOL
   Select the IP protocol value to match.
sport NUMBER|NUMBER-NUMBER
   Select the source port value to match, in which NUMBER-NUMBER

corresponds to a range of port values.
dport NUMBER|NUMBER-NUMBER
   Select the destination port value to match, in which NUMBER-NUMBER corresponds to a range of port values.
tun_id TUN_ID
   Select the network tunnel identifier to match.

By providing the routing rule table 134 and the routing rule cache table 136 in the storage system 104 of FIG. 1b, in which each routing rule stored in the routing rule cache table 136 is orthogonal to routing rules stored in the routing rule table 134, fast and easy table lookups of routing rules in the routing rule cache table 136 can be achieved, while avoiding the possibility of any routing rules in the routing rule cache table 136 being general enough to encompass a more specific routing rule in the routing rule table 134. In this way, performance degradation resulting from use of a routing rule table with a high number of entries can be reduced, without risking accessing the wrong routing table for forwarding a packet transmission to a client.

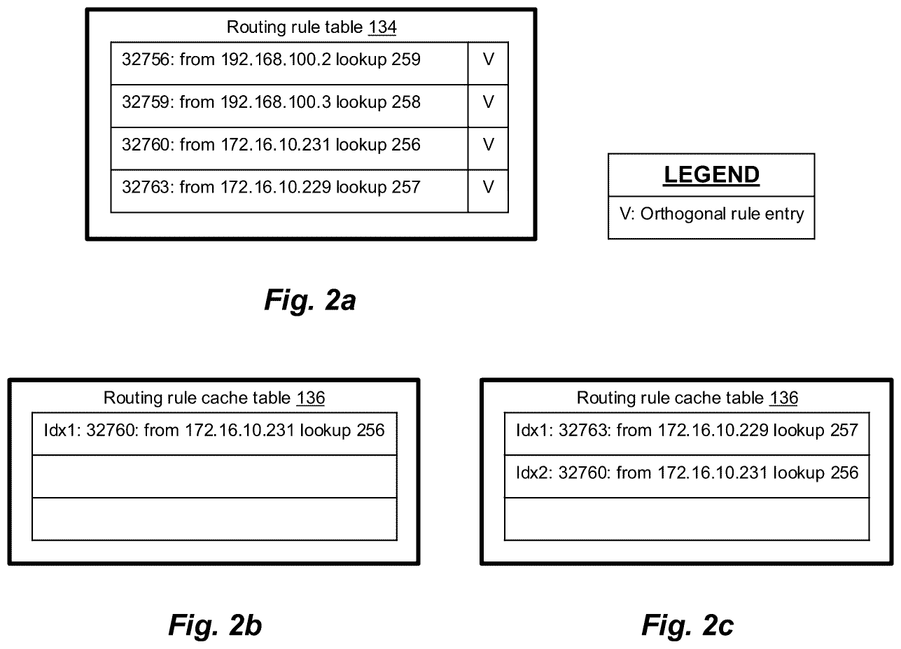

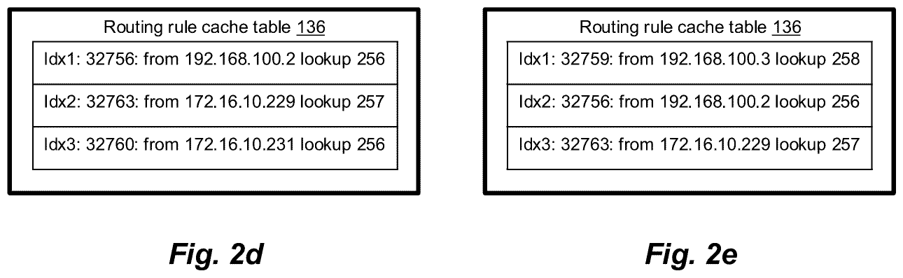

The disclosed techniques will be further understood with reference to the following illustrative examples, as well as FIGS. 1b, 2a-2e, 3a, 3b, 4a, 4b, and 5. In a first illustrative example, as described herein with reference to FIGS. 1b and 2a-2e, packet transmission processing is performed by the storage node 110.0 (see FIG. 1b) using the routing rule table 134 (see FIGS. 1b and 2a), resulting in a series of changes in the routing rule cache table 136 (see FIGS. 2b, 2c, 2d, and 2e). In a second illustrative example, as described herein with reference to

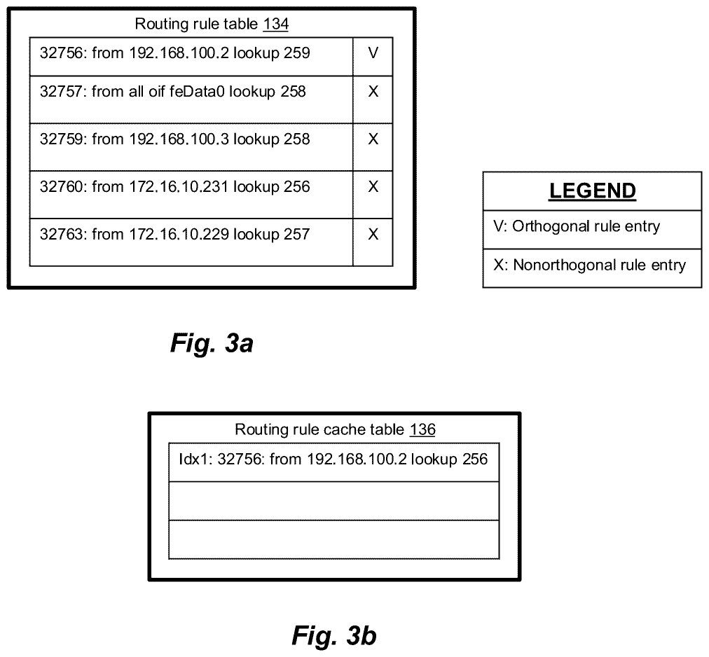

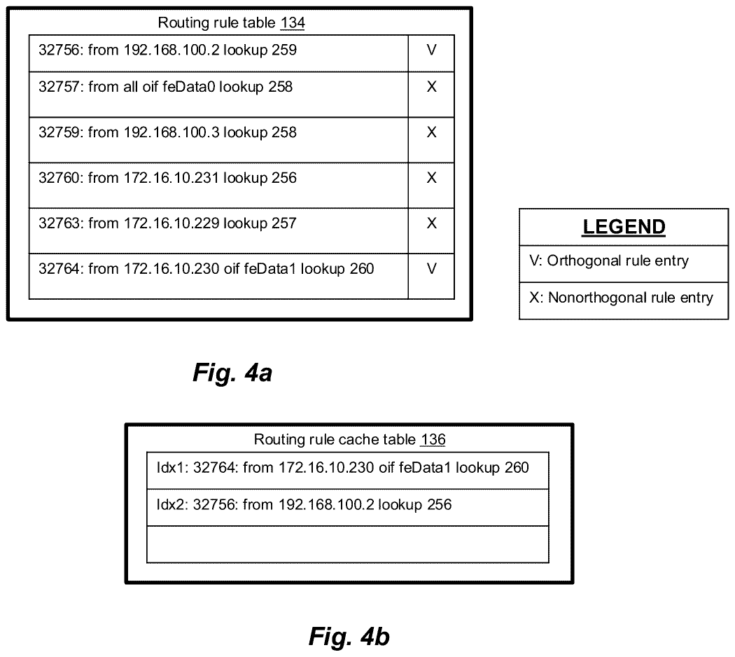

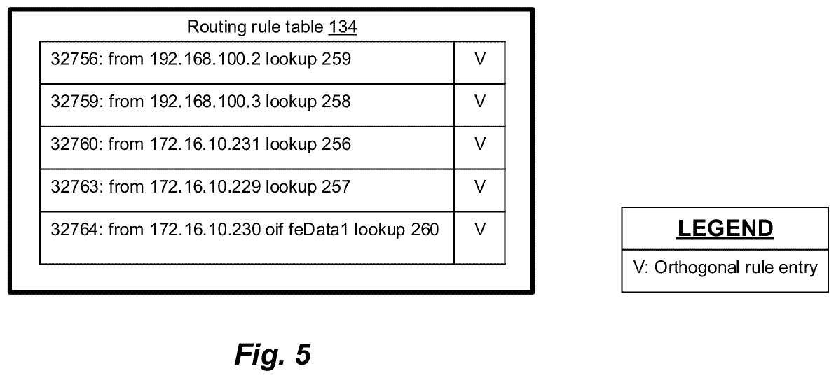

FIGS. 1b, 3a, and 3b, a first newly created routing rule is added to the routing rule table 134 (see FIGS. 1b and 3a), resulting in another change in the routing rule cache table 136 (see FIG. 3b). In a third illustrative example, as described herein with reference to FIGS. 1b, 4a, and 4b, a second newly created routing rule is added to the routing rule table 134 (see FIGS. 1b and 4a), resulting in a further change in the routing rule cache table 136 (see FIG. 4b). In a fourth illustrative example, as described herein with reference to FIGS. 1b and 5, the previously added first routing rule is removed from the routing rule table 134, resulting in a change in the routing rule table 134 (see FIG. 5). In each of these illustrative examples, the routing rule cache table 136 is configured to contain a maximum of three (3) entries. It is noted, however, that the maximum number of entries in the routing rule cache table 136 can be set (e.g., by a module parameter) to any other suitable value.

Regarding the first illustrative example, the routing rule table 134 (see FIG. 2a) is configured to contain the following list of entries:
32756: from 192.168.100.2 lookup 259 (1)
32759: from 192.168.100.3 lookup 258 (2)
32760: from 172.16.10.231 lookup 256 (3)
32763: from 172.16.10.229 lookup 257 (4)

In the entries listed above (see reference numerals (1) through (4)), the values, 32756, 32759, 32760, and 32763, correspond to numerical priority values, which determine the order in which routing rules in the routing rule table 134 are to be evaluated. As described herein, such numerical priority values can be specified using the “priority PREFERENCE” attribute, in which PREFERENCE corresponds to an unsigned integer value, and a higher integer value corresponds to a lower priority. As such, the routing rule with the highest integer value, “32763” (see reference numeral (4)), has the lowest priority, and therefore is to be evaluated last, while the routing rule with the lowest integer value, “32756” (see reference numeral (1)), has the highest priority, and therefore is to be evaluated first. Further, the numerical expressions, 192.168.100.2, 192.168.100.3, 172.16.10.231, and 172.16.10.229, correspond to source IP addresses. For example, the source IP address, 192.168.100.2, may correspond to IP address “A” of MACvLAN device (“feData0”) 120.0 (see FIG. 1b), the source IP address, 192.168.100.3, may correspond to IP address “B” of MACvLAN device (“feData1”) 120.1 (see FIG. 1b), and so on. As described herein, such source IP addresses can be specified using the “from PREFIX” attribute, in which the term, “from”, corresponds to a selector term, and PREFIX corresponds to a source address prefix. Still further, the values, 259, 258, 256, and 257, correspond to the routing tables 259, 258, 256, and 257, respectively, included in the network stack 132 (see FIG. 1b). It is noted that, in the entries listed above (see reference numerals (1) through (4)), the term, “lookup”, corresponds to an “action predicate”. Accordingly, upon evaluation of each routing rule in the routing rule table 134 (see FIG. 2a), the selector term (i.e., from) of the routing rule is applied to the source IP address, and, if a packet to be transmitted matches the selector term, then the action (i.e., lookup 259, 258, 256, or 257) is performed.

In this first example, for each entry (see reference numerals (1) through (4)) in the routing rule table 134 (see FIG. 2a), a determination is made as to whether the corresponding routing rule is orthogonal to each routing rule of higher priority, if any, in the routing rule table 134 (see FIG. 2a). In other words, a determination is made as to whether the routing rule's combination of attributes is not encompassed by the attributes of a routing rule(s) of higher priority, if any. In the routing rule table 134 (see FIG. 2a), the routing rule, “32756: from 192.168.100.2 lookup 259” (see reference numeral (1)), has the highest priority, and therefore, by default, is deemed orthogonal, as indicated by the mark, “V” (see FIG. 2a). Further, because the combination of attributes of the routing rule, “32759: from 192.168.100.3 lookup 258” (see reference numeral (2)), is not encompassed by the attributes of the routing rule, “32756: from 192.168.100.2 lookup 259” (see reference numeral (1)), the routing rule, “32759: from 192.168.100.3 lookup 258” (see reference numeral (2)), is deemed orthogonal, as indicated by the mark, “V” (see FIG. 2a). Still further, because the combination of attributes of the routing rule, “32760: from 172.16.10.231 lookup 256” (see reference numeral (3)), is not encompassed by the attributes of the routing rule, “32756: from 192.168.100.2 lookup 259” (see reference numeral (1)), or the routing rule, “32759: from 192.168.100.3 lookup 258” (see reference numeral (2)), the routing rule, “32760: from 172.16.10.231 lookup 256” (see reference numeral (3)), is deemed orthogonal, as indicated by the mark, “V” (see FIG. 2a). Yet further, because the combination of attributes of the routing rule, “32763: from 172.16.10.229 lookup 257” (see reference numeral (4)), is not encompassed by the attributes of the routing rule, “32756: from 192.168.100.2 lookup 259” (see reference numeral (1)), the routing rule, “32759: from 192.168.100.3 lookup 258” (see reference numeral (2)), or the routing rule, “32760: from 172.16.10.231 lookup 256” (see reference numeral (3)), the routing rule, “32763: from 172.16.10.229 lookup 257” (see reference numeral (4)), is deemed orthogonal, as indicated by the mark, “V” (see FIG. 2a).

In this first example, a first transmission of a packet to a client is processed, in which the packet matches the selector term, “from 172.16.10.231” (see reference numeral (3)). Because the routing rule, “32760: from 172.16.10.231 lookup 256” (see reference numeral (3)), is deemed orthogonal and marked, “V”, the routing rule, “32760: from 172.16.10.231 lookup 256” (see reference numeral (3)), is placed in the first or top position, “Idx1”, of the routing rule cache table 136 (see FIG. 2b). Next, a second transmission of a packet to the client is processed, in which the packet matches the selector term, “from 172.16.10.229” (see reference numeral (4)). Because the routing rule, “32763: from 172.16.10.229 lookup 257” (see reference numeral (4)), is deemed orthogonal and marked, “V”, the routing rule, “32763: from 172.16.10.229 lookup 257” (see reference numeral (4)), is placed in the top position, “Idx1”, of the routing rule cache table 136 (see FIG. 2c), and the routing rule, “32760: from 172.16.10.231 lookup 256” (see reference numeral (3)), is moved from the top position, “Idx1”, to the second position, “Idx2”, of the routing rule cache table 136 (see FIG. 2c).

Next, a third transmission of a packet to the client is processed, in which the packet matches the selector term, “from 192.168.100.2” (see reference numeral (1)). Because the routing rule, “32756: from 192.168.100.2 lookup 259” (see reference numeral (1)), is deemed orthogonal and marked, “V”, the routing rule, “32756: from 192.168.100.2 lookup 259” (see reference numeral (1)), is placed in the top position, “Idx1”, of the routing rule cache table 136 (see FIG. 2d), the routing rule, “32763: from 172.16.10.229 lookup 257” (see reference numeral (4)), is moved from the top position, “Idx1”, to the second position, “Idx2”, of the routing rule cache table 136 (see FIG. 2d), and the routing rule, “32760: from 172.16.10.231 lookup 256” (see reference numeral (3)), is moved from the second position, “Idx2”, to the third position, “Idx3”, of the routing rule cache table 136 (see FIG. 2d).

Next, a fourth transmission of a packet to the client is processed, in which the packet matches the selector term, “from 192.168.100.3” (see reference numeral (2)). Because the routing rule, “32759: from 192.168.100.3 lookup 258” (see reference numeral (2)), is deemed orthogonal and marked, “V”, the routing rule, “32759: from 192.168.100.3 lookup 258” (see reference numeral (2)), is placed in the top position, “Idx1”, of the routing rule cache table 136 (see FIG. 2e), the routing rule, “32756: from 192.168.100.2 lookup 259” (see reference numeral (1)), is moved from the top position, “Idx1”, to the second position, “Idx2”, of the routing rule cache table 136 (see FIG. 2e), and the routing rule, “32763: from 172.16.10.229 lookup 257” (see reference numeral (4)), is moved from the second position, “Idx2”, to the third position, “Idx3”, of the routing rule cache table 136 (see FIG. 2e). Because the routing rule cache table 136 is configured to contain a maximum of three (3) entries, the routing rule, “32760: from 172.16.10.231 lookup 256” (see reference numeral (3)), is removed from the third position, “Idx3”, and effectively dropped from the routing rule cache table 136.

Regarding the second illustrative example, an entry corresponding to the first newly created routing rule, namely, “32757: from all oif feData0 lookup 258”, is placed in the routing rule table 134 between the routing rule, “32756: from 192.168.100.2 lookup 259”, and the routing rule, “32759: from 192.168.100.3 lookup 258”, due to the numerical priority value, “32757”, of the first newly created routing rule falling between the values, “32756” and “32759”. As a result, the routing rule table 134 (see FIG. 3a) is reconfigured to contain the following list of entries:
32756: from 192.168.100.2 lookup 259 (5)
32757: from all oif feData0 lookup 258 (6)
32759: from 192.168.100.3 lookup 258 (7)
32760: from 172.16.10.231 lookup 256 (8)
32763: from 172.16.10.229 lookup 257 (9)

In this second example, for each entry (see reference numerals (5) through (9)) in the routing rule table 134 (see FIG. 3a), a determination is made as to whether the corresponding routing rule is orthogonal to each routing rule of higher priority, if any, in the routing rule table 134. In other words, a determination is made as to whether the routing rule's combination of attributes is not encompassed by the attributes of a routing rule(s) of higher priority, if any. In the routing rule table 134 (see FIG. 3a), the routing rule, “32756: from 192.168.100.2 lookup 259” (see reference numeral (5)), has the highest priority, and therefore, by default, is deemed orthogonal, as indicated by the mark, “V” (see FIG. 3a). However, the combination of attributes of the routing rule, “32757: from all oif feData0 lookup 258” (see reference numeral (6)), is encompassed by the attributes of the routing rule, “32756: from 192.168.100.2 lookup 259” (see reference numeral (5)), due to the selector term, “from all oif feData0”, matching the routing rule, “32756: from 192.168.100.2 lookup 259” (see reference numeral (5)), which can act on packets from the source IP address, “192.168.100.2”, on any outgoing device. The routing rule, “32757: from all oif feData0 lookup 258” (see reference numeral (6)), is therefore deemed nonorthogonal, as indicated by the mark, “X” (see FIG. 3a). Likewise, the selector term, “from all oif feData0”, matches (i) the routing rule, “32759: from 192.168.100.3 lookup 258” (see reference numeral (7)), which can act on packets from the source IP address, “192.168.100.3”, on any outgoing device, (ii) the routing rule, “32760: from 172.16.10.231 lookup 256” (see reference numeral (8)), which can act on packets from the source IP address, “172.16.10.231”, on any outgoing device, and (iii) the routing rule, “32763: from 172.16.10.229 lookup 257” (see reference numeral (9)), which can act on packets from the source IP address, “172.16.10.229”, on any outgoing device. Accordingly, the routing rules, “32759: from 192.168.100.3 lookup 258” (see reference numeral (7)), “32760: from 172.16.10.231 lookup 256” (see reference numeral (8)), and “32763: from 172.16.10.229 lookup 257” (see reference numeral (9)), are each deemed nonorthogonal, as indicated by the mark, “X” (see FIG. 3a). For example, the marks, “V” and “X”, may be implemented as a Boolean flag.

In this second example, in response to the routing rule, “32759: from 192.168.100.3 lookup 258” (see reference numeral (7)), and the routing rule, “32763: from 172.16.10.229 lookup 257” (see reference numeral (9)), being deemed nonorthogonal, the routing rule, “32759: from 192.168.100.3 lookup 258” (see reference numeral (7)), previously in the first position, “Idx1”, of the routing rule cache table 136 (see FIG. 2e), and the routing rule, “32763: from 172.16.10.229 lookup 257” (see reference numeral (9)), previously in the third position, “Idx3”, of the routing rule cache table 136 (see FIG. 2e), are removed from the routing rule cache table 136 (see FIG. 3b), and the routing rule, “32756: from 192.168.100.2 lookup 259” (see reference numeral (5)), is moved to the top position, “Idx1”, of the routing rule cache table 136 (see FIG. 3b). It is noted that, if a transmission of a packet to the client is processed, in which the packet matches the selector term, “from 192.168.100.3” (see reference numeral (7)), or the selector term, “from 172.16.10.229” (see reference numeral (9)), neither of the corresponding routing rules, “32759: from 192.168.100.3 lookup 258” (see reference numeral (7)) or “32763: from 172.16.10.229 lookup 257” (see reference numeral (9)), would be placed in the routing rule cache table 136 (see FIG. 3b), due to both of these routing rules being marked nonorthogonal, “X” (see FIG. 3a).

Regarding the third illustrative example, an entry corresponding to the second newly created routing rule, namely, “32764: from 172.16.10.230 oif feData1 lookup 260”, is placed in the routing rule table 134 directly below the routing rule, “32763: from 172.16.10.229 lookup 257”, due to the numerical priority value, “32764”, of the second newly created routing rule being greater than the value, “32763”. As a result, the routing rule table 134 (see FIG. 4a) is reconfigured to contain the following list of entries:
32756: from 192.168.100.2 lookup 259 (10)
32757: from all oif feData0 lookup 258 (11)
32759: from 192.168.100.3 lookup 258 (12)
32760: from 172.16.10.231 lookup 256 (13)
32763: from 172.16.10.229 lookup 257 (14)
32764: from 172.16.10.230 oif feData1 lookup 260 (15)

As described herein with reference to the second illustrative example, the routing rules, “32757: from all oif feData0 lookup 258” (see reference numeral (6)), “32759: from 192.168.100.3 lookup 258” (see reference numeral (7)), “32760: from 172.16.10.231 lookup 256” (see reference numeral (8)), and “32763: from 172.16.10.229 lookup 257” (see reference numeral (9)), were each deemed nonorthogonal, as indicated by the mark, “X” (see FIG. 3a). However, because the combination of attributes of the routing rule, “32764: from 172.16.10.230 oif feData1 lookup 260” (see reference numeral (15)), is not encompassed by the attributes of any of the routing rules, “32756: from 192.168.100.2 lookup 259” (see reference numeral (10)), “32757: from all oif feData0 lookup 258” (see reference numeral (11)), “32759: from 192.168.100.3 lookup 258” (see reference numeral (12)), “32760: from 172.16.10.231 lookup 256” (see reference numeral (13)), and “32763: from 172.16.10.229 lookup 257” (see reference numeral (14)), the routing rule, “32764: from 172.16.10.230 oif feData1 lookup 260” (see reference numeral (15)), is deemed orthogonal, as indicated by the mark, “V” (see FIG. 4a).

In this third example, a transmission of a packet to the client is processed, in which the packet matches the selector term, “from 172.16.10.230 oif feData1” (see reference numeral (15)). Because the routing rule, “32764: from 172.16.10.230 oif feData1 lookup 260” (see reference numeral (15)), is deemed orthogonal and marked, “V”, the routing rule, “32764: from 172.16.10.230 oif feData1 lookup 260” (see reference numeral (15)), is placed in the top position, “Idx1”, of the routing rule cache table 136 (see FIG. 4b), and the routing rule, “32756: from 192.168.100.2 lookup 259” (see reference numeral (10)) is moved from the top position, “Idx1”, to the second position, “Idx2”, of the routing rule cache table 136 (see FIG. 4b).

Regarding the fourth illustrative example, the routing rule, “32757: from all oif feData0 lookup 258” (see reference numeral (11)) is removed from the routing rule table 134. As a result, the routing rule table 134 (see FIG. 5) is reconfigured to contain the following list of entries:
32756: from 192.168.100.2 lookup 259 (16)
32759: from 192.168.100.3 lookup 258 (17)
32760: from 172.16.10.231 lookup 256 (18)
32763: from 172.16.10.229 lookup 257 (19)
32764: from 172.16.10.230 oif feData1 lookup 260 (20)

As described herein with reference to the third illustrative example, the routing rules, “32757: from all oif feData0 lookup 258” (see reference numeral (11)), “32759: from 192.168.100.3 lookup 258” (see reference numeral (12)), “32760: from 172.16.10.231 lookup 256” (see reference numeral (13)), and “32763: from 172.16.10.229 lookup 257” (see reference numeral (14)), were each deemed nonorthogonal, as indicated by the mark, “X” (see FIG. 4a). However, because the routing rule, “32757: from all oif feData0 lookup 258” (see reference numeral (11)) has been removed from the routing rule table 134, each of the routing rules, “32759: from 192.168.100.3 lookup 258” (see reference numeral (17)), “32760: from 172.16.10.231 lookup 256” (see reference numeral (18)), and “32763: from 172.16.10.229 lookup 257” (see reference numeral (19)), is now orthogonal to each routing rule of higher priority in the routing rule table 134, as indicated by the mark, “V” (see FIG. 5).

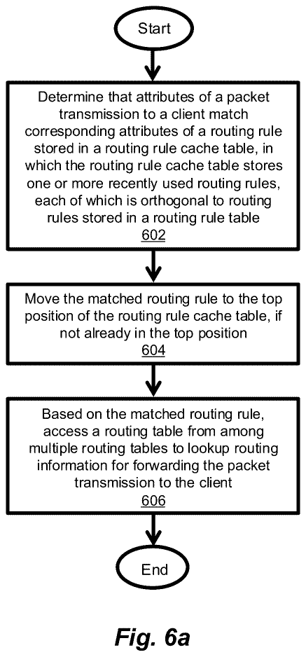

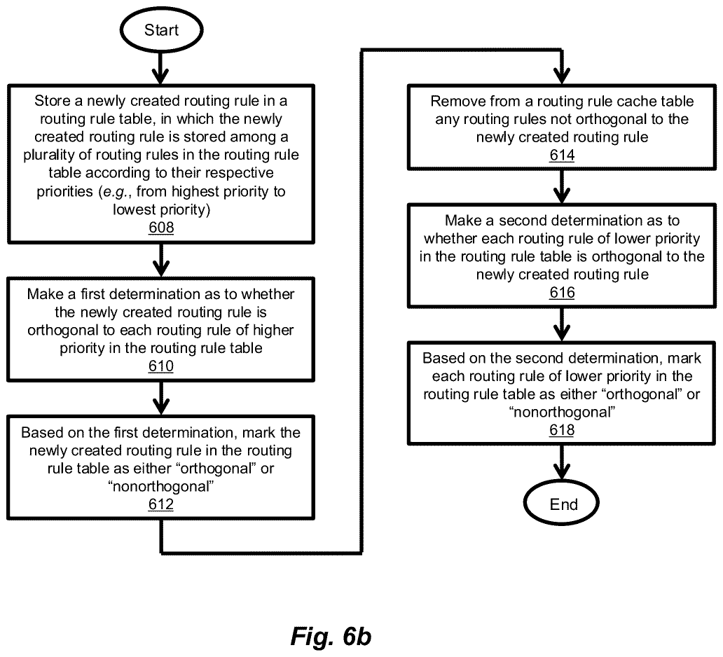

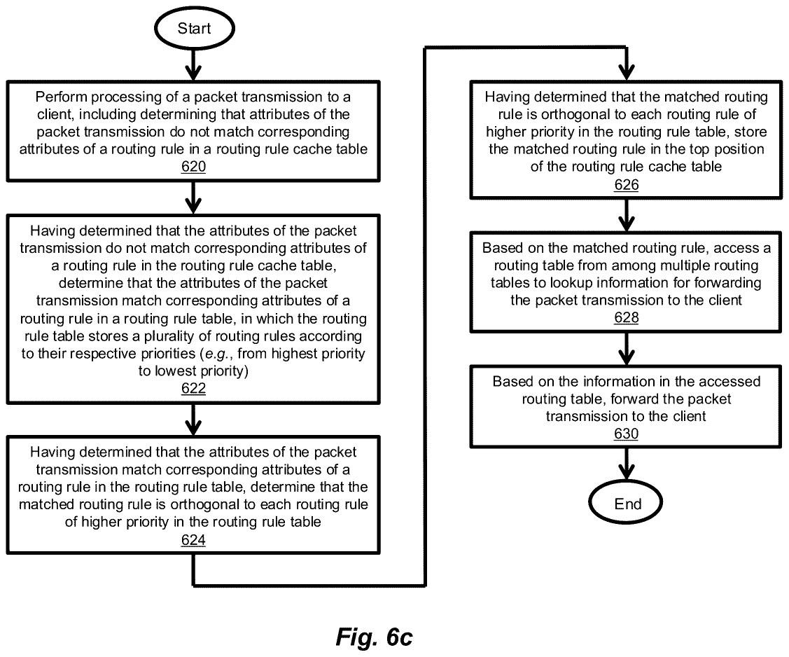

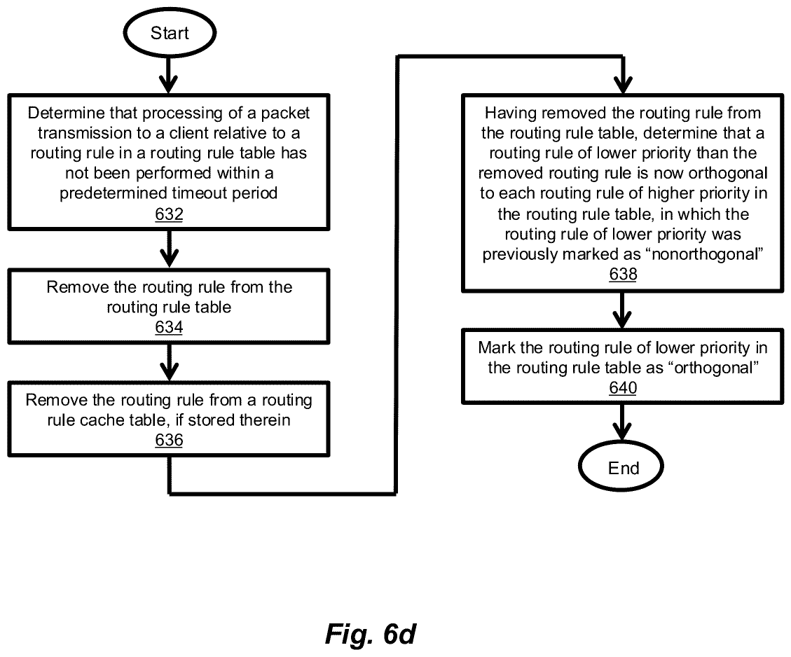

Exemplary methods of providing a smart routing rule caching mechanism are described herein with reference to FIGS. 6a-6d. In a first method, as described herein with reference to FIG. 6a, a routing rule cache table is provided for orthogonal routing rule entries. In a second method, as described herein with reference to FIG. 6b, a newly created routing rule is stored in a routing rule table. In a third method, as described herein with reference to FIG. 6c, the routing rule table and/or the routing rule cache table are accessed during processing of a packet transmission to a client. In a fourth method, as described herein with reference to FIG. 6d, a routing rule is removed from the routing rule table.

In the first method, as depicted in block 602 (see FIG. 6a), attributes of a packet transmission to a client are determined to match corresponding attributes of a routing rule stored in a routing rule cache table, in which the routing rule cache table stores one or more recently used routing rules, each of which is orthogonal to routing rules stored in a routing rule table. As depicted in block 604, the matched routing rule is moved to the top position of the routing rule cache table, if not already in the top position. As depicted in block 606, based on the matched routing rule, a routing table is accessed from among multiple routing tables to lookup routing information for forwarding the packet transmission to the client.

In the second method, as depicted in block 608 (see FIG. 6b), a newly created routing rule is stored in a routing rule table, in which the newly created routing rule is stored among a plurality of routing rules in the routing rule table according to their respective priorities (e.g., from highest priority to lowest priority). As depicted in block 610, a first determination is made as to whether the newly created routing rule is orthogonal to each routing rule of higher priority in the routing rule table. As depicted in block 612, based on the first determination, the newly created routing rule is marked in the routing rule table as either “orthogonal” or “nonorthogonal”. As depicted in block 614, any routing rules not orthogonal to the newly created routing rule are removed from a routing rule cache table. As depicted in block 616, a second determination is made as to whether each routing rule of lower priority in the routing rule table is orthogonal to the newly created routing rule. As depicted in block 618, based on the second determination, each routing rule of lower priority is marked in the routing rule table as either “orthogonal” or “nonorthogonal”.

In the third method, as depicted in block 620 (see FIG. 6c), processing of a packet transmission to a client is performed, including determining that attributes of the packet transmission do not match corresponding attributes of a routing rule in a routing rule cache table. As depicted in block 622, having determined that the attributes of the packet transmission do not match corresponding attributes of a routing rule in the routing rule cache table, it is determined that the attributes of the packet transmission match corresponding attributes of a routing rule in a routing rule table, in which the routing rule table stores a plurality of routing rules according to their respective priorities (e.g., from highest priority to lowest priority). As depicted in block 624, having determined that the attributes of the packet transmission match corresponding attributes of a routing rule in the routing rule table, it is determined that the matched routing rule is orthogonal to each routing rule of higher priority in the routing rule table. As depicted in block 626, having determined that the matched routing rule is orthogonal to each routing rule of higher priority in the routing rule table, the matched routing rule is stored in the top position of the routing rule cache table. As depicted in block 628, based on the matched routing rule, a routing table is accessed from among multiple routing tables to lookup information for forwarding the packet transmission to the client. As depicted in block 630, based on the information in the accessed routing table, the packet transmission is forwarded to the client.

In the fourth method, as depicted in block 632 (see FIG. 6d), it is determined that processing of a packet transmission to a client relative to a routing rule in a routing rule table has not been performed within a predetermined timeout period. As depicted in block 634, the routing rule is removed from the routing rule table. As depicted in block 636, the routing rule is removed from a routing rule cache table, if stored therein. As depicted in block 638, having removed the routing rule from the routing rule table, it is determined that a routing rule of lower priority than the removed routing rule is now orthogonal to each routing rule of higher priority in the routing rule table, in which the routing rule of lower priority was previously marked as “nonorthogonal”. As depicted in block 640, the routing rule of lower priority is marked in the routing rule table as “orthogonal”.

Several definitions of terms are provided below for the purpose of aiding the understanding of the foregoing description, as well as the claims set forth herein.

As employed herein, the term “storage system” is intended to be broadly construed to encompass, for example, private or public cloud computing systems for storing data, as well as systems for storing data comprising virtual infrastructure and those not comprising virtual infrastructure.

As employed herein, the terms “client”, “host”, and “user” refer, interchangeably, to any person, system, or other entity that uses a storage system to read/write data.

As employed herein, the term “storage device” may refer to a storage array including multiple storage devices. Such storage devices may refer to any non-volatile memory (NVM) devices, including hard disk drives (HDDs), solid state drives (SSDs), flash devices (e.g., NAND flash devices, NOR flash devices), and/or similar devices that may be accessed locally and/or remotely, such as via a storage area network (SAN).

As employed herein, the term “storage array” may refer to a storage system used for page-based, block-based, file-based, or other object-based storage. Such a storage array may include, for example, dedicated storage hardware containing HDDs, SSDs, and/or flash drives.

As employed herein, the term “storage entity” may refer to a filesystem, an object storage, a virtualized device, a logical unit (LU), a logical volume (LV), a logical device, a physical device, and/or a storage medium.

As employed herein, the term “LU” may refer to a logical entity provided by a storage system for accessing data from the storage system and may be used interchangeably with a logical volume (LV). The term “LU” may also refer to a logical unit number (LUN) for identifying a logical unit, a virtual disk, or a virtual LUN.

As employed herein, the term “physical storage unit” may refer to a physical entity such as a storage drive or disk or an array of storage drives or disks for storing data in storage locations accessible at addresses. The term “physical storage unit” may be used interchangeably with the term “physical volume”.

As employed herein, the term “storage medium” may refer to a hard drive or flash storage, a combination of hard drives and flash storage, a combination of hard drives, flash storage, and other storage drives or devices, or any other suitable types and/or combinations of computer readable storage media. Such a storage medium may include physical and logical storage media, multiple levels of virtual-to-physical mappings, and/or disk images. The term “storage medium” may also refer to a computer-readable program medium.

As employed herein, the term “IO request” or “IO” may refer to a data input or output request such as a write request or a read request.

As employed herein, the terms, “such as”, “for example”, “e.g.”, “exemplary”, and variants thereof refer to non-limiting embodiments and have meanings of serving as examples, instances, or illustrations. Any embodiments described herein using such phrases and/or variants are not necessarily to be construed as preferred or more advantageous over other embodiments, and/or to exclude incorporation of features from other embodiments.

As employed herein, the term “optionally” has a meaning that a feature, element, process, etc., may be provided in certain embodiments and may not be provided in certain other embodiments. Any particular embodiment of the present disclosure may include a plurality of optional features unless such features conflict with one another.

While various embodiments of the present disclosure have been particularly shown and described, it will be understood by those skilled in the art that various changes in form and details may be made therein without departing from the scope of the present disclosure, as defined by the appended claims.

What is claimed is:

1. A method comprising:
determining that attributes of a packet transmission to a client match corresponding attributes of a routing rule stored in a routing rule cache table, the routing rule cache table storing one or more routing rules, each stored routing rule being orthogonal to routing rules stored in a routing rule table;
based on the matched routing rule, accessing a routing table from among multiple routing tables to lookup routing information for forwarding the packet transmission to the client; and
forwarding the packet transmission to the client using the routing information.

2. The method of claim 1 comprising:
storing a newly created routing rule in the routing rule table, the newly created routing rule being stored among a plurality of routing rules in the routing rule table according to their respective priorities; and
making a first determination as to whether the newly created routing rule is orthogonal to each routing rule of higher priority in the routing rule table.

3. The method of claim 2 comprising:
based on the first determination, marking the newly created routing rule in the routing rule table as either “orthogonal” or “nonorthogonal”.

4. The method of claim 3 comprising:
removing any routing rules not orthogonal to the newly created routing rule from the routing rule cache table; and
making a second determination as to whether each routing rule of lower priority than the newly created routing rule in the routing rule table is orthogonal to the newly created routing rule.

5. The method of claim 4 comprising:
based on the second determination, marking each routing rule of lower priority than the newly created routing rule in the routing rule table as either “orthogonal” or “nonorthogonal”.

6. The method of claim 1 comprising:
performing processing of the packet transmission to the client, including determining that attributes of the packet transmission do not match corresponding attributes of a routing rule in the routing rule cache table; and
having determined that the attributes of the packet transmission do not match corresponding attributes of a routing rule in the routing rule cache table, determining that the attributes of the packet transmission match corresponding attributes of a routing rule in the routing rule table, the routing rule table storing a plurality of routing rules according to their respective priorities.

7. The method of claim 6 comprising:
having determined that the attributes of the packet transmission match corresponding attributes of a routing rule in the routing rule table, determining that the matched routing rule is orthogonal to each routing rule of higher priority in the routing rule table.

8. The method of claim 7 comprising:
having determined that the matched routing rule is orthogonal to each routing rule of higher priority in the routing rule table, storing the matched routing rule in a top position of the routing rule cache table.

9. The method of claim 8 comprising:
based on the matched routing rule, accessing a routing table from among multiple routing tables to lookup information for forwarding the packet transmission to the client; and
based on the information in the accessed routing table, forwarding the packet transmission to the client.

10. The method of claim 1 comprising:
determining that processing of a packet transmission to the client relative to a specified routing rule in the routing rule table has not been performed within a predetermined timeout period.

11. The method of claim 10 comprising:
removing the routing rule from the routing rule table; and
removing the routing rule from the routing rule cache table, if stored therein.

12. The method of claim 11 comprising:
having removed the routing rule from the routing rule table, determining that a routing rule of lower priority than the removed routing rule is now orthogonal to each routing rule of higher priority in the routing rule table, the routing rule of lower priority being previously marked as “nonorthogonal”; and
marking the routing rule of lower priority in the routing rule table as “orthogonal”.

13. A system comprising:
a memory; and
processing circuitry configured to execute program instructions out of the memory to:
determine that attributes of a packet transmission to a client match corresponding attributes of a routing rule stored in a routing rule cache table,
wherein the routing rule cache table stores one or more routing rules, and
wherein each stored routing rule is orthogonal to routing rules stored in a routing rule table;
based on the matched routing rule, access a routing table from among multiple routing tables to lookup routing information for forwarding the packet transmission to the client; and
forward the packet transmission to the client using the routing information.

14. The system of claim 13 wherein the processing circuitry is configured to execute the program instructions out of the memory to:
store a newly created routing rule in the routing rule table,
wherein the newly created routing rule is stored among a plurality of routing rules in the routing rule table according to their respective priorities;
make a first determination as to whether the newly created routing rule is orthogonal to each routing rule of higher priority in the routing rule table; and
based on the first determination, mark the newly created routing rule in the routing rule table as either “orthogonal” or “nonorthogonal”.

15. The system of claim 14 wherein the processing circuitry is configured to execute the program instructions out of the memory to:
remove any routing rules not orthogonal to the newly created routing rule from the routing rule cache table;
make a second determination as to whether each routing rule of lower priority than the newly created routing rule in the routing rule table is orthogonal to the newly created routing rule; and
based on the second determination, mark each routing rule of lower priority than the newly created routing rule in the routing rule table as either “orthogonal” or “nonorthogonal”.

16. The system of claim 15 wherein the processing circuitry is configured to execute the program instructions out of the memory to:
perform processing of the packet transmission to the client, including determining that attributes of the packet transmission do not match corresponding attributes of a routing rule in the routing rule cache table; and
having determined that the attributes of the packet transmission do not match corresponding attributes of a routing rule in the routing rule cache table, determine that the attributes of the packet transmission match corresponding attributes of a routing rule in the routing rule table, the routing rule table storing a plurality of routing rules according to their respective priorities.

17. The system of claim 16 wherein the processing circuitry is configured to execute the program instructions out of the memory to:
having determined that the attributes of the packet transmission match corresponding attributes of a routing rule in the routing rule table, determine that the matched routing rule is orthogonal to each routing rule of higher priority in the routing rule table; and
having determined that the matched routing rule is orthogonal to each routing rule of higher priority in the routing rule table, store the matched routing rule in a top position of the routing rule cache table.

18. The system of claim 17 wherein the processing circuitry is configured to execute the program instructions out of the memory to:
based on the matched routing rule, access a routing table from among multiple routing tables to lookup information for forwarding the packet transmission to the client; and
based on the information in the accessed routing table, forward the packet transmission to the client.

19. The system of claim 13 wherein the processing circuitry is configured to execute the program instructions out of the memory to:
determine that processing of a packet transmission to the client relative to a specified routing rule in the routing rule table has not been performed within a predetermined timeout period;
remove the routing rule from the routing rule table;
remove the routing rule from the routing rule cache table, if stored therein;
having removed the routing rule from the routing rule table, determine that a routing rule of lower priority than the removed routing rule is now orthogonal to each routing rule of higher priority in the routing rule table,
wherein the routing rule of lower priority was previously marked as “nonorthogonal”; and
mark the routing rule of lower priority in the routing rule table as “orthogonal”.

20. A computer program product including a set of non-transitory, computer-readable media having program instructions that, when executed by processing circuitry, cause the processing circuitry to perform a method comprising:
determining that attributes of a packet transmission to a client match corresponding attributes of a routing rule stored in a routing rule cache table, the routing rule cache table storing one or more routing rules, each stored routing rule being orthogonal to routing rules stored in a routing rule table;
based on the matched routing rule, accessing a routing table from among multiple routing tables to lookup routing information for forwarding the packet transmission to the client; and
forwarding the packet transmission to the client using the routing information.
